(19) United States
(12) Patent Application Publication
(10) Pub. No.: US 2021/0204518 A1
(43) Pub. Date: Jul. 8, 2021

(54) BALL-SHAPED PET TOY

(71) Applicant: Sabine Crane, San Clemente, CA (US)

(72) Inventor: Sabine Crane, San Clemente, CA (US)

(21) Appl. No.: 17/145,254

(22) Filed: Jan. 8, 2021

Related U.S. Application Data
(60) Provisional application No. 62/958,671, filed on Jan. 8, 2020.

(51) Int. Cl. A01K 15/02

(52) U.S. Cl. CPC A01K 15/026

(57) ABSTRACT

A spherical pet toy has at least one knotted and frayed cord end exiting the spherical body at, at least one point on the surface. An exemplary version has four knotted and frayed cord ends exiting at four different points on the spherical surface. An object, such as a smaller ball, internal to the pet toy moves around as the pet toy is handled by an animal, providing aural and tactile feedback to the playing animal. The knotted and frayed cord ends satisfy an animal's chewing instincts while cleaning the animal's teeth.

### CROSS-REFERENCE TO RELATED APPLICATIONS

This application claims the benefit of U.S. Provisional Patent Application No. 62/958,671, filed on Jan. 8, 2020, and incorporated herein by reference.

### STATEMENT REGARDING FEDERALLY SPONSORED RESEARCH AND DEVELOPMENT

Not Applicable.

### FIELD OF THE INVENTION

The present invention pertains generally to toys for use in the recreational activities of a pet. More particularly, the present invention pertains to a spherical shaped toy body with one or more knotted cord ends exiting the body. The present invention is particularly, but not exclusively, useful as a dog toy.

### BACKGROUND OF THE INVENTION

Humans and dogs have associated with each other for thousands of years. Today, dogs may be kept to guard livestock, hunt, or perform other types of labor, but it is also common for dogs to be kept as pets. As a result of the popularity of pet ownership, dog toys have become a massive industry, with sales in the billions of dollars annually.

### SUMMARY OF THE INVENTION

Disclosed is a pet toy having at least one cord end exiting the body at, at least one point on the surface. An object, such as a smaller ball, internal to the pet toy moves around as the pet toy is handled by an animal, providing aural and tactile feedback to the playing animal. The cord end satisfies an animal's chewing instincts while cleaning the animal's teeth.

A preferred embodiment has four knotted and frayed cord ends exiting at four points around a great circle of a spherical body of the toy's surface. A “great circle” is a circle that divides the sphere into two equal hemispheres. Placement of cord ends along a great circle of the spherical body allows for greater ease in manufacturing the spherical pet toy. Nonetheless, alternative embodiments include toys with different shapes, including, for example football-shapes or polyhedrons, and other arrangements of cord end exit points. The pet toy can be of any size suitable for play with a pet, but typically ranges from approximately five to seven inches in diameter.

### DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a top view of a preferred embodiment of a ball-shaped pet toy;

FIG. 2 is a view of a portion of the body of the ball-shaped pet toy illustrating the internal components and structure of the toy;

FIG. 3 is a view of a portion of the body of the ball-shaped pet toy illustrating the internal components and structure of a preferred embodiment of the toy; and

FIG. 4 is an illustration of an exemplary use of the ball-shaped pet toy in which a dog is chewing on a cord end protruding out from the interior of the ball-shaped pet toy.

### DETAILED DESCRIPTION OF THE PREFERRED EMBODIMENT

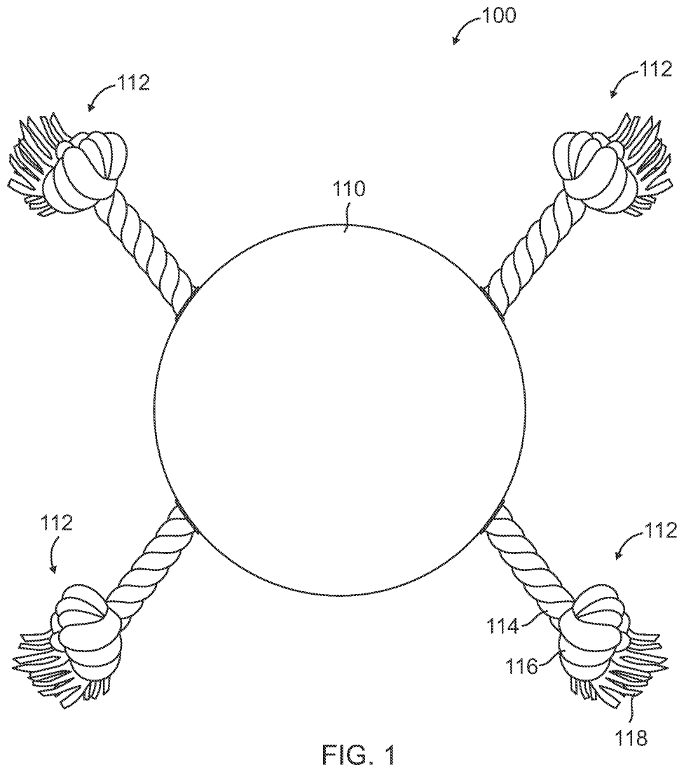

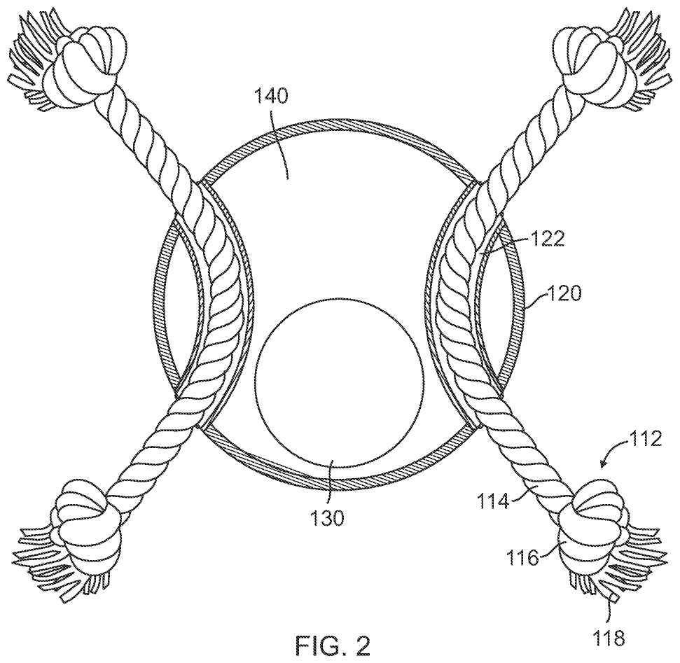

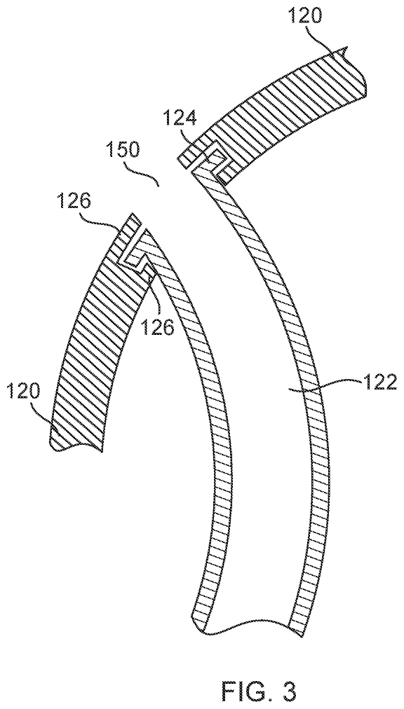

Referring initially to FIG. 1, an outer structure 110 is shown, which forms an inner chamber 140 (shown in FIG. 2). In a preferred embodiment, a ball-shaped toy 100 is illustrated, showing a spherical body 110 with four cord ends 112 exiting at separate openings 150 (shown in FIG. 3) of the spherical body. In a preferred embodiment, two cords 114 provide the four ends 112, as discussed in further detail below. Each end 112 has a knot 116 and a frayed extremity 118.

Referring now to FIG. 2, a hemisphere 120, being half of spherical body 110, is illustrated, showing the internal structure of ball-shaped toy 100, with an inner chamber 140. Each cord 114 is passed through a curved tube 122 that is seated into the spherical body 110. An inner structure, such as ball 130, is located inside ball-shaped toy 100 in order to provide aural and tactile feedback as an animal plays with ball-shaped toy 100 and thus maintain the animal's interest by providing it with physical and intellectual stimulation.

Hemispheres 120 and tubes 122 are made from a sufficiently durable material that is safe for an animal to handle and chew on. In a preferred embodiment the hemispheres 120 and tubes 122 are made from thermoplastic rubber although any material that is durable and resistant to being punctured by the dog's teeth can be used. The same material is used for both hemispheres 120 and tubes 122 in a preferred embodiment but different materials may be used. In a preferred embodiment, the hemispheres 120 and tubes 122 are formed through injection molding, in some cases in combination with other processes such as cutting, machining, milling, 3D printing or other processes. The aforementioned processes and any process known in the art, or combinations thereof, may be used in making the hemispheres 120 and tubes 122.

Two hemispheres are joined with tubes 122 in place and secured by receivers 126 (shown Zin FIG. 3) and an object such as ball 130 in the interior defined by hemispheres 120 in order to create an exemplary preferred embodiment of ball-shaped dog toy 100. In a preferred embodiment, the two hemispheres 120 are permanently fixed together with a non-toxic adhesive or other bonding material or bonding method known in the art.

A preferred embodiment of cord 114 is a braided fabric passed through a tube 122 and then knotted at ends 112. Rope, twine, and other types of cord may also be used.

In the depicted preferred embodiment, the receivers 126 are along the perimeter of hemisphere 120 where it joins another hemisphere 120, thus resulting in the knotted ends 112 of cords 114 protruding from four separate points along the same great circle—that is, at separate points along the meeting perimeters of hemispheres 120—of the assembled spherical body 110. The described structure using two cords 114 each passed through its own tube 122 which is held into place with receivers 126 and lip 124 (shown in FIG. 3) provides a structural rigidity to the ball-shaped pet toy 100 and a pleasing resistance to a playing animal as a knotted end 112 of a cord 114 is tugged on. Nonetheless, alternative embodiments include other internal structures; for example, a short, separate cord 114 may be used for each knotted cord end 112 which exits, or sits exterior to, the spherical body 110. The shorter cords may each be knotted on both ends, with a knot on one end holding that end internal to the spherical body 110, and the other knot serving as part of a knotted end 112 exterior to the spherical body 110. Alternatively, two cords knotted inside the toy may be used. In this way, the necessity of tubes 122 is eliminated, and the feel of tugging on a knotted end 112 is slightly different.

Referring now to FIG. 3, a lip 124 on each end of each tube 122 fits into two receivers 126 in hemisphere 120. Each hemisphere 120 has corresponding receivers 126, so that when ball-shaped toy 100 is fully assembled, each lip 124 is fitted into two receivers 126, which together entirely surround the lip 124, holding tube 122 into place at each opening 150. This preferred embodiment has the benefit of avoiding tube 122 from being dislodged from hemisphere 120 during aggressive play, thus increasing durability and safety. However, in an alternate embodiment lip 124 and receivers 126 are removed and tube 122 is attached to hemisphere 120 with, for example, a non-toxic adhesive or other bonding material or bonding method known in the art.

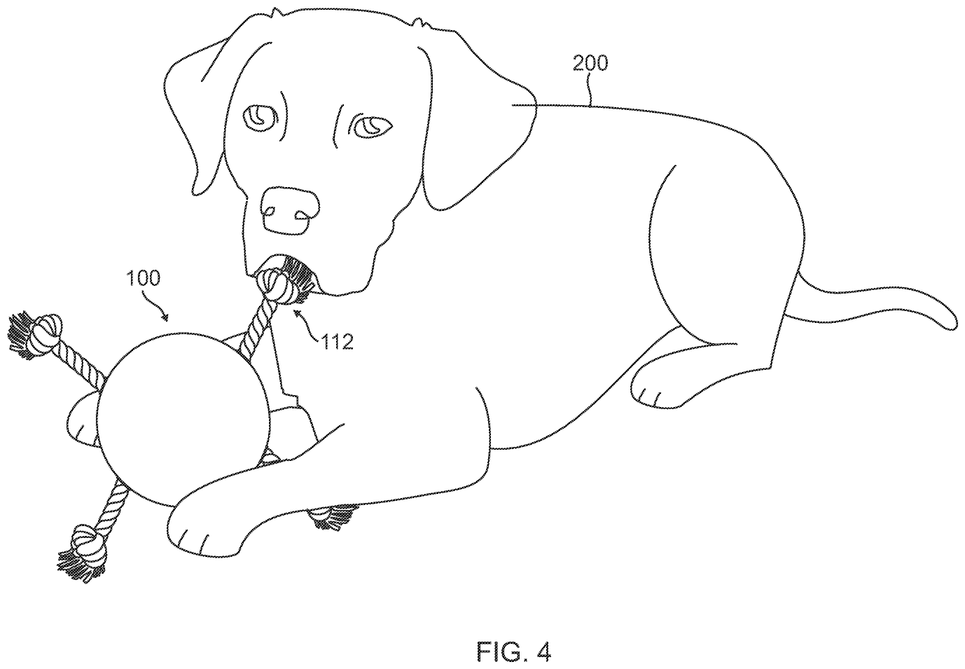

Referring now to FIG. 4, a dog 200 playing with a ball-shaped pet toy 100 is illustrated. In use, an animal, such as dog 200, will often hold the spherical body 110 of ball-shaped pet toy 100 in place, for example, with its paws, while chewing on a knotted cord end 112. The texture of knotted cord end 112 has a teeth-cleaning effect as dog 200 (or another animal) chews on it during play. At other times, the animal will bat or kick the ball-shaped pet toy 100 around, resulting in noise and tactile feedback as ball 130 (shown in FIG. 2) collides with the interior surface of spherical body 110, including tubes 122 (shown in FIG. 2). In a preferred embodiment ball 130 is made from a tennis ball although it can be made from the same material as hemisphere 120 and tube 122. In yet another embodiment ball 130 is made of a more ridge material so that ball 130 rattles inside hemisphere 120 during play.

While there have been shown what are presently considered to be preferred embodiments of the present invention, it will be apparent to those skilled in the art that various changes and modifications can be made herein without departing from the scope and spirit of the invention.

While the above description contains specific details regarding certain materials, shapes, and other teachings, it is understood that embodiments of the invention or any combination of them may be practiced without these specific details. These details should not be construed as limitations on the scope of any embodiment, but merely as exemplifications of the presently preferred embodiments. In other instances, well known structures, elements, and techniques have not been shown to clearly explain the details of the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A pet toy comprising:
an outer structure forming an inner chamber;
the outer structure including a plurality of openings;
a pair of opposing tubes extending internally between said openings;
a pair of cords passing through said pair of opposing tubes and extending beyond the outer structure through said plurality of openings; and
an inner structure being contained within the inner chamber.

2. The pet toy of claim 1 wherein the outer structure is a sphere.

3. The pet toy of claim 1 wherein the inner structure is a sphere.

4. The pet toy of claim 1 wherein the tubes further comprise a lip at each end and wherein the openings further comprise two receivers for securing said tubes.

5. The pet toy of claim 4 wherein the pair of cords pass through said pair of opposing tubes and are knotted at each end.

6. The pet toy of claim 1 wherein the outer structure, inner structure and tubes are made of thermoplastic rubber.
